(19) United States
(12) Patent Application Publication
(10) Pub. No.: US 2004/0128446 A1
(43) Pub. Date: Jul. 1, 2004

(54) Value profiling with low overhead

(76) Inventor: Carole Dulong, Saratoga, CA (US)

Correspondence Address: Timothy N. Trop, TROP, PRUNER & HU, P.C., 8554 KATY FWY, STE 100, HOUSTON, TX, 77024-1841, US

(21) Appl. No.: 10/330,762

(22) Filed: Dec. 27, 2002

(51) Int. Cl. G06F 9/44

(52) U.S. Cl. 711/131; 717/130

(57) ABSTRACT

In one embodiment of the present invention, a method includes organizing a memory buffer to receive profile data corresponding to an instruction of interest within a code segment; instrumenting the code segment to store the profile data in the memory buffer; storing the profile data in the memory buffer; and sampling the profile data in the memory buffer.

### BACKGROUND

The present invention is directed to software for execution in a computer system, and more specifically to software development tools for performing value profiling.

Software compilers compile or translate source code in a source language into target code in a target language. The target code may be executed directly by a computer system or linked by a suitable linker with other target code for execution by the computer system.

Certain compilers use value profiling to obtain information useful in optimization of code. Such value profiling typically obtains values generated by program instructions and maintains statistics regarding the values. When it is known that a particular instruction most often returns the same value, certain optimizations may be possible. For example if it is known that a multiplication operand is frequently zero, a program may be optimized by inserting code to skip the multiplication step. Similar optimizations are available for other operations including other mathematical operations, memory accesses, indirect branching, and the like.

However, value profiling can be very time intensive and intrusive. One manner of performing value profiling is to “instrument” code by adding additional code and creating an additional database to capture the desired values. This of course alters the course of code of the program under analysis and may require many iterations of the code to successfully optimize the program. Other value profiling methods use an interpreter to randomly interpret instructions. However this increases complexity and raises overhead. Thus it is desired to provide profile feedback with minimum intrusion.

### BRIEF DESCRIPTION OF THE DRAWINGS

FIG. 1 is a flow chart of a program flow in accordance with one embodiment of the present invention.

FIG. 2 is a flow chart of a program flow in accordance with a second embodiment of the present invention.

FIG. 3 is a block diagram of an architecture in accordance with one embodiment of the present invention.

FIG. 4A is a block diagram of a memory buffer in accordance with one embodiment of the present invention.

FIG. 4B is a block diagram of a memory buffer in accordance with a second embodiment of the present invention.

FIG. 5 is a block diagram of a virtual function binding for a class C in accordance with one embodiment of the present invention.

FIG. 6 is a block diagram of a system in accordance with one embodiment of the present invention.

### detailed description

In one embodiment, value profiling may be performed by first organizing a memory space, such as a memory buffer. The code to be analyzed may then be instrumented with instructions for obtaining the profile data. During execution, desired data may be profiled and stored in the memory buffer along with a program counter for the instruction(s) of interest. The memory buffer then may be sampled by a profiling tool in the same manner as hardware performance monitors such as hardware buffers (e.g., processor hardware monitors) are sampled during profiling. The data obtained from the memory buffer then may be stored in a profile database by the profiling tool. In such an embodiment, no processing of profile data is done at runtime. This permits value profiling to be performed that is user transparent and very lightweight. As such, profiling may be present in all binaries. More so, because the profiling is lightweight, it does not change the behavior of the program of interest, and hardware and software may be profiled at the same time and without the need for numerous iterations of the program, in certain embodiments.

Value profiling in accordance with certain embodiments of the present invention may be used to obtain information regarding many different values of interest. Such values may include, for example, string length, shift and integer divide operands, and floating point operands.

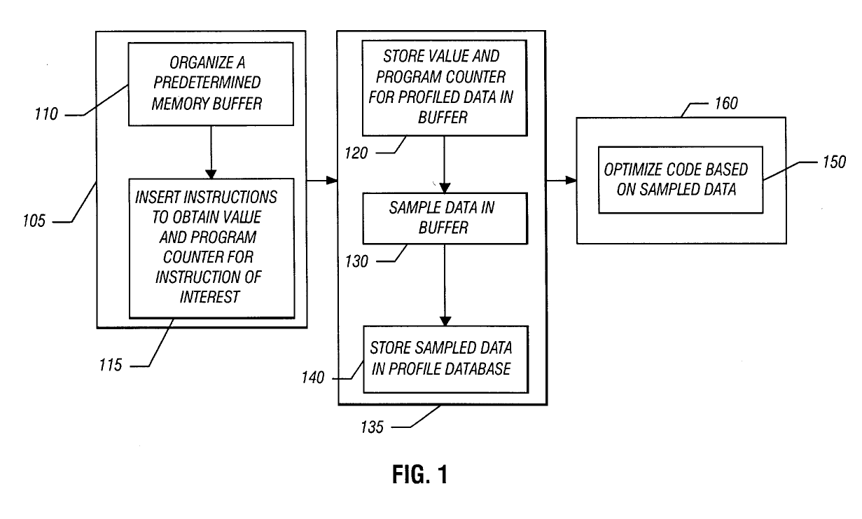

Referring now to FIG. 1, shown is a flow chart of a program flow in accordance with one embodiment of the present invention. As shown in FIG. 1, a program of interest may be compiled for instrumentation (block 105). Such instrumentation may include organizing a memory buffer (block 110). While it is to be understood that such a memory buffer may take many different forms, in one embodiment this memory buffer may be a circular buffer. In certain embodiments, the circular buffer may have a size of between approximately 8 and 16 kilobytes (KB), while smaller or larger buffers may exist in other embodiments. However, in other embodiments, a saturating buffer may be used. Next, the program to be profiled may be instrumented by inserting instructions to obtain information regarding one or more instructions of interest. As shown in FIG. 1, in one embodiment these instructions may include instructions to obtain the value and program counter of an instruction of interest (block 115). In one embodiment, the above acts may be performed by a compiler during the compilation process.

After the compiling process is completed, the executable program may be executed for profiling (block 135). During such execution, information regarding the data being profiled may be stored in the buffer (block 120). In one embodiment, the information stored may be the value and the program counter corresponding to the instruction being performed.

Further shown in FIG. 1, data in the buffer may be sampled (block 130). In one embodiment, the data may be sampled by an extension of existing profiling tools, such as the VTune™ Performance Analyzer tool available from Intel Corporation, Santa Clara, Calif. When the data has been sampled, the buffer may be managed to provide sufficient storage for further data. For example in one embodiment, upon sampling, an address pointer of the buffer may be reset to the beginning of the buffer.

Sampled data may be stored in a profile database (block 140). In one embodiment, this profile database may include data from both hardware monitors and the memory buffer. While the profile database may be arranged differently in various embodiments, in one embodiment data from the memory buffer may be stored sequentially with data from hardware monitors. Alternately, data may be stored in different sections of the profile database, depending on data type.

As shown in FIG. 1, in one embodiment the code (i.e., the program of interest) may be recompiled for optimization(s) (block 160). For example, the code may be optimized based on the sampled data (block 150). Various optimizations may be possible based on the particular instruction(s) under analysis and the profile data corresponding thereto.

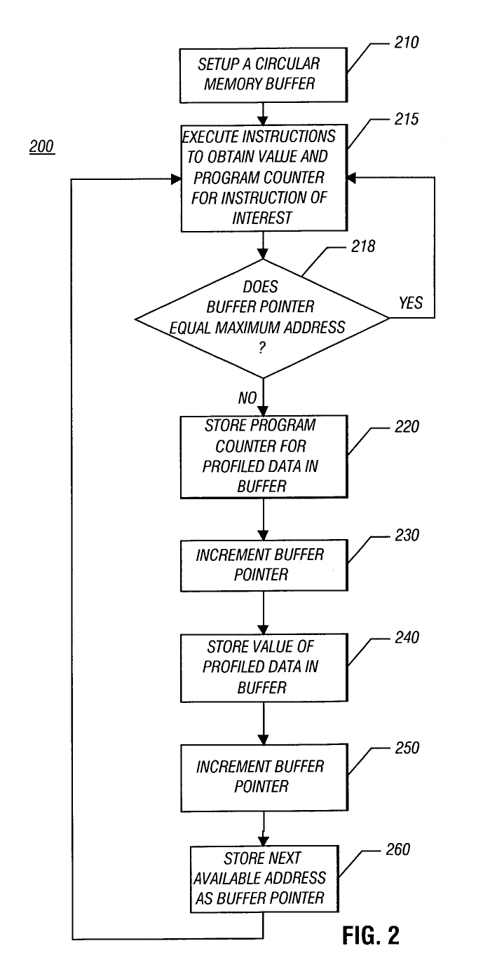

Referring now to FIG. 2, shown is a flow chart of a program flow in accordance with a second embodiment of the present invention. As shown in FIG. 2, this embodiment relates to use of a circular buffer as the memory buffer. Program flow 200 begins by setting up a circular memory buffer (block 210). Next, the program to be profiled may be executed to obtain the value and program counter of an instruction of interest (block 215).

During execution, it is determined whether the buffer pointer equals the maximum address of the circular buffer (diamond 218). In other words, a check is made to determine whether the circular buffer has reached its end. If so, control passes back to block 215 for execution of the next instruction of the program which includes instructions to store such profile data. Alternately, if the buffer pointer has not reached its maximum address, control passes to block 220. There, the program counter corresponding to the profiled data may be stored in the buffer (block 220). The buffer pointer is then incremented (block 230). Then the value of the profiled data may be stored in the buffer (block 240), and the buffer pointer may be incremented again (block 250). The next available address is stored as the buffer pointer (block 260), and control passes back to block 215.

While not shown in FIG. 2, in parallel with execution of the program undergoing profiling, in one embodiment, a profiling tool may similarly check the buffer pointer. If the maximum address has been reached, the buffer may be sampled, and the buffer pointer may be reset. If the maximum address has not been reached, the profiling tool may wait to sample the data in the buffer. Also not shown in FIG. 2, when the profiling has been completed, the profiled data may be analyzed to optimize code, for example.

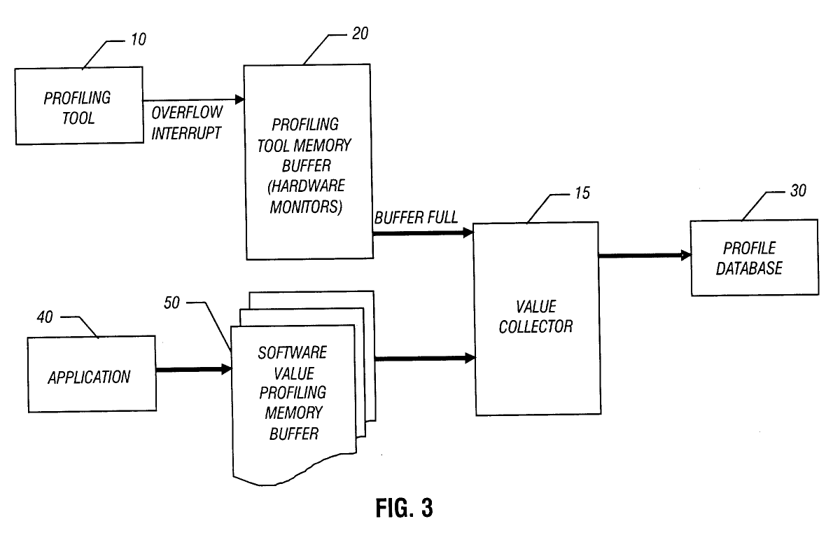

Referring now to FIG. 3, shown is a block diagram of an architecture in accordance with one embodiment of the present invention. As shown in FIG. 3, a profiling tool 10 (for example, a sampling driver of the tool) may sample one or more hardware monitors upon receipt of an overflow interrupt from the hardware monitor(s) and store the data therefrom in a profiling tool memory buffer 20 (“hardware memory buffer 20” ). These hardware monitors may be performance monitors, such as present in a central processing unit (CPU) (e.g., the ITANIUM™ family of processors available from Intel Corporation).

When hardware memory buffer 20 is full, a Buffer Full signal is sent to value collector 15. In one embodiment, value collector 15 may be a code module which is part of profiling tool 10. In one embodiment, value collector 15 may process the information obtained from hardware memory buffer 20 and provide it to profile database 30. For example, value collector 15 may aggregate the information and provide information regarding the most frequent values obtained (and tally counts therefor).

Also shown in FIG. 3 is an application program 40. Application program 40 may be instrumented with code in accordance with an embodiment of the present invention. As such during execution of application program 40, profiled data may be stored in software value profiling memory buffer 50 (“software memory buffer 50” ). In one embodiment, when value collector 15 receives the Buffer Full signal from hardware memory buffer 20 and samples data therefrom, value collector 15 may also sample software memory buffer 50 at substantially the same time. Thus in this embodiment data in software memory buffer 50 may be sampled in the same manner that hardware memory buffer 20 is sampled by the profiling tool. However, in other embodiments software memory buffer 50 may be sampled independently from memory buffer 20. For example, value collector 15 may set up its own timer to wake up and to sample software memory buffer 50. More so, in certain embodiments software memory buffer 50 may be sized so that it is full when the hardware memory buffer 20 is full. However, buffers need not be the same size, as data may be stored to the buffers at different rates.

Upon sampling data in software memory buffer 50, value collector 15 may similarly aggregate profile data and provide it to profile database 30. In one embodiment, value collector 15 may aggregate values based on the program count, and maintain the most frequent values and counts per program count. In one embodiment, a compiler may use the four most frequent values in connection with optimizing a program. In certain embodiments, it may be desirable to maintain approximately the ten most frequent values obtained during a profiling session, and provide them from value collector 15 to profile database 30. In such manner, long running applications may be profiled and profile database 30 may be kept of workable size.

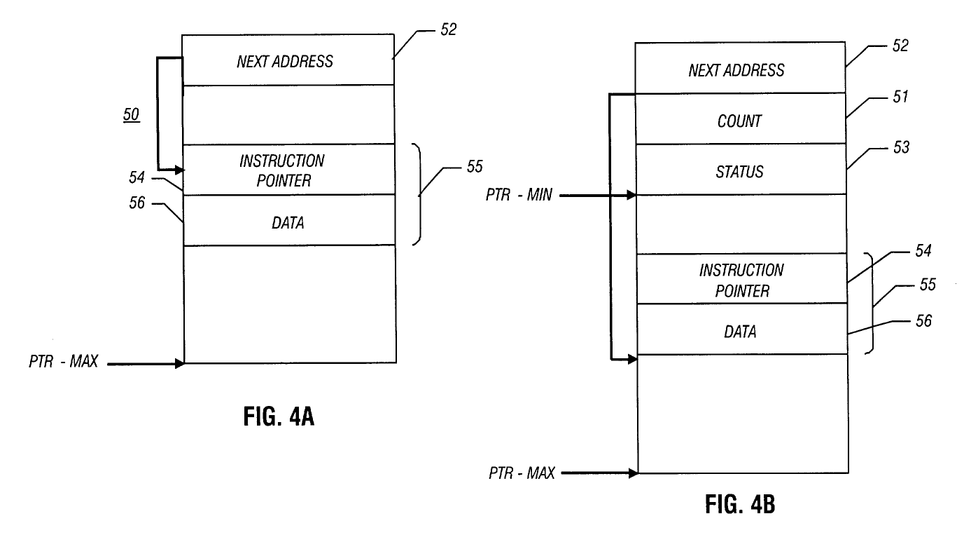

Referring now to FIG. 4A, shown is a block diagram of a software memory buffer in accordance with one embodiment of the present invention. As shown in FIG. 4A, memory buffer 50 may include a pointer 52 which contains the value of the next available address in memory buffer 50 (shown as “Next Address”). More so, shown in FIG. 4A is an example entry of profile data, which may include an instruction pointer value 54 and a data value 56. As used herein, “instruction pointer” and “program counter” are equivalent terms referring to the address of the next instruction to be performed by the CPU. This pair of data may make up one entry 55. Also shown in FIG. 4A, Ptr-Max refers to the final location of the memory buffer.

In one embodiment, the following code may be used to instrument a code segment to perform value profiling using memory buffer 50 of FIG. 4A:

Get_IP_of_interest

Ld Ptr=(Next address)

If Ptr<Ptr_max

Store Ptr=IP_of_interest

Ptr++

Store Ptr=Value X

Ptr++

Store (Next address)=Ptr.

This code thus stores the profile data and manages the pointer of the memory buffer. As seen, the instrumented code is very lightweight and may be present in all binaries, thus avoiding a special compile process by the user. In this embodiment, value collector 15 may test Next Address and sample memory buffer 50 when it is full.

Referring now to FIG. 4B, shown is a block diagram of a software memory buffer in accordance with a second embodiment of the present invention. In this embodiment, memory buffer 50 may be a circular buffer. In addition to pointer 52 and entry 55, memory buffer 50 of FIG. 4B includes a count value 51. This count value 51 may contain the number of valid entries in buffer 50. More so, a status value 53 is included. This status value in one embodiment may be either a “Busy” or a “Free” status, which indicates when data is being written into memory buffer 50 so that the buffer is not sampled during a write operation. Also shown in FIG. 4B are Ptr-Min and Ptr-Max which refer, respectively to the first available memory address location and the final memory address location in the memory buffer.

In one embodiment, the following code may be used to instrument a code segment to perform value profiling using memory buffer 50 of FIG. 4B:

Get_IP_of_interest

Store Status=busy

Ld Ptr=(Next address)

Ld Cnt=(Count)

Ptr=Ptr+(Cnt modulo max)

Store Ptr=IP_of_interest

Ptr++

Store Ptr=Value X

Ptr++

Cnt=Cnt+1

Store (Count)=Cnt

Store Status=free

This code similarly stores the profile data in the memory buffer and manages the memory buffer. In this embodiment, to avoid a race condition the instrumentation code does not write the next address.

In certain embodiments, profiling may be synchronous with the application program. That is, the application program may be running while the buffer is sampled. In an embodiment using a saturating buffer, the value profiler may check whether the buffer is full, and reset the Next Address to the buffer start when sampling is done. In an embodiment using a circular buffer, the value profiler may test buffer status, and if it is full, modifications may be enabled in flight to complete profiling by redirecting future samples to a dummy buffer until processing of the buffer is done.

While embodiments of the present invention may be used in connection with various profiling instances, in one embodiment virtual function calls may be optimized using value profiling.

If a function in a base class definition is declared to be virtual, and is declared exactly the same way (including the return type) in one or more derived classes, then all calls to that function using pointers or references of type “base class” will invoke the function that is specified by the object being pointed at, and not by the type of pointer itself. In such a situation, the compiler cannot make a decision as to which function will get called, and the function call is sent to the instance that has its address stored in the pointer.

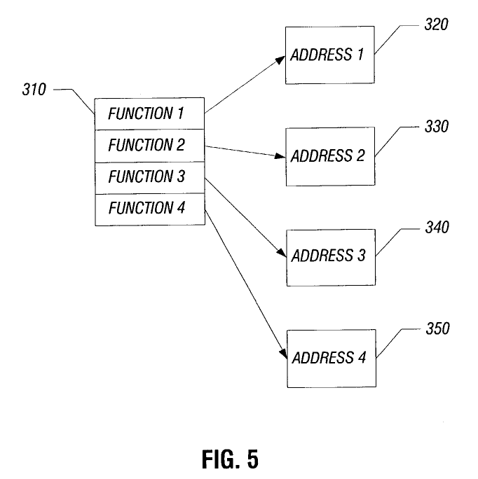

Optimizing the virtual function call may eliminate costly indirect branches as often as possible. Referring now to FIG. 5, shown is a virtual function binding for a class C (block 310). This binding is a list of addresses for functions 1 through 4 (beginning respectively at addresses 1 through 4 (blocks 320, 330, 340, and 350)), to which control will branch depending on the type of operand passed to the function call. As shown in FIG. 5, with x objects of class C and a vptr address of VTable C, Load Rtarget=vptr(x), branch Rtarget causes an indirect branch. Determining a most frequent value for vptr(x) may thus aid in optimization.

For the most frequent values of vptr(x), if vptr(x)==1, assuming 1 is the most frequent value, the code may be optimized by branching to the immediate address via Br Address1. Otherwise an indirect branch occurs according to the following code: Load Rtarget=vptr(x); Br Rtarget. Thus the compiler needs to know most frequent values of vptr(x). When this is not given by profiling of the indirect branch target, value profiling of vptr(x) may be performed.

In this embodiment, the code may be instrumented as follows to perform value profiling in accordance with one embodiment of the present invention:

Setup MemBuffer (StartAddress, length)

Load MemPtr=(Next_Address)

If MemPtr<MaxAddress then

Store MemPtr=PC

MemPtr++

Store MemPtr=vptr(x)

MemPtr++

Store (Next_Address)=MemPtr.

In one embodiment, the original branch instructions may follow these instructions. This instrumentation code thus sets up a memory buffer at the beginning of the profiling run, and the one load and three store instructions are used to store the program counter, value of type(x), and the pointer to the next buffer address. Also a check is made to determine whether the buffer if full. If so, no data is written to the buffer. Storage of the program counter provides the ability to match the value with the instruction to which it corresponds.

In another embodiment, value profiling may be used to value profile a divide operand. The divide operand can be optimized away with shift instructions (typically much faster than a divide operation) if the divider is a power of two. In this embodiment, divide instructions may be used to profile the desired values. In such an embodiment, a memory buffer is setup (as above) and the instruction pointer and the value obtained from the divide instruction may be stored therein for later sampling. In this embodiment the following instructions may be used:

Load MemPtr=(Next_Address)

If MemPtr<MaxAddress then

Store MemPtr=IP

MemPtr++

Store MemPtr=Rdivider

MemPtr++

Store (Next_Address)=MemPtr

Divide Rresult=Rvalue, Rdivider.

The final instruction (i.e., “Divide Rresult . . . ”) is the original divide instruction.

Thus in certain embodiments, profiling may be done with low runtime overhead in a manner that is user transparent. More so, in such embodiments many different types of value sampling may be performed including sampling for values associated with virtual function calls, mathematical operations, memory accesses and the like. Thus, rather than randomly profiling data, in certain embodiments data associated with particular instructions of interest may be profiled.

Embodiments may be implemented in code and may be stored on a storage medium having stored thereon instructions which can be used to program a computer system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), flash memories, electrically erasable programmable read-only memories (EEPROMs), magnetic or optical cards, or any type of media suitable for storing electronic instructions.

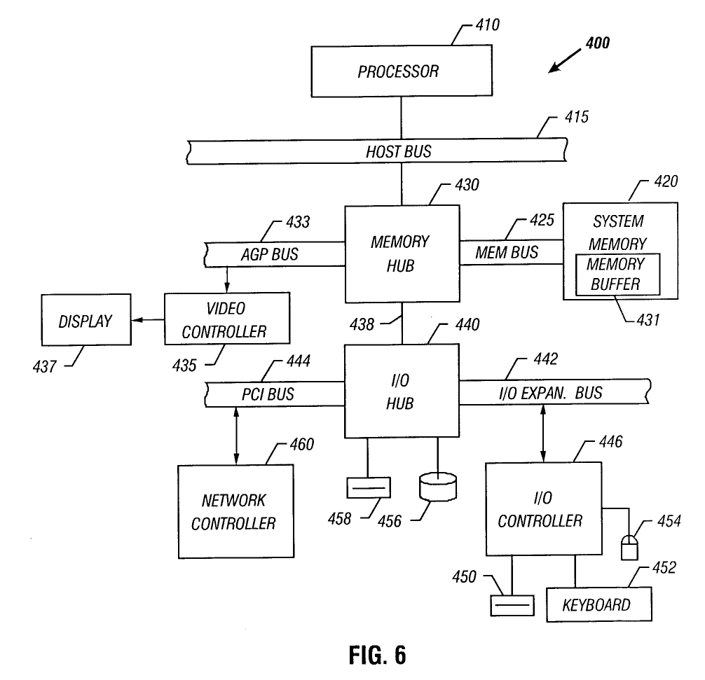

Example embodiments may be implemented in software for execution by a suitable computer system configured with a suitable combination of hardware devices. FIG. 6 is a block diagram of computer system 400 with which embodiments of the invention may be used.

Now referring to FIG. 6, in one embodiment, computer system 400 includes a processor 410, which may include a general-purpose or special-purpose processor such as a microprocessor, microcontroller, a programmable gate array (PGA), and the like. As used herein, the term “computer system” may refer to any type of processor-based system, such as a desktop computer, a server computer, a laptop computer, an appliance or set-top box, or the like.

The processor 410 may be coupled over a host bus 415 to a memory hub 430 in one embodiment, which may be coupled to a system memory 420 via a memory bus 425. As shown in FIG. 6, system memory 420 may include a memory buffer 431, which in one embodiment may be a circular buffer, for the storage of profile data. The memory hub 430 may also be coupled over an Advanced Graphics Port (AGP) bus 433 to a video controller 435, which may be coupled to a display 437. The AGP bus 433 may conform to the Accelerated Graphics Port Interface Specification, Revision 2.0, published May 4, 1998, by Intel Corporation, Santa Clara, Calif.

The memory hub 430 may also be coupled (via a hub link 438) to an input/output (I/O) hub 440 that is coupled to a input/output (I/O) expansion bus 442 and a Peripheral Component Interconnect (PCI) bus 444, as defined by the PCI Local Bus Specification, Production Version, Revision 2.1 dated in June 1995. The I/O expansion bus 442 may be coupled to an I/O controller 446 that controls access to one or more I/O devices. As shown in FIG. 6, these devices may include in one embodiment storage devices, such as a floppy disk drive 450 and input devices, such as keyboard 452 and mouse 454. The I/O hub 440 may also be coupled to, for example, a hard disk drive 456 and a compact disc (CD) drive 458, as shown in FIG. 6. It is to be understood that other storage media may also be included in the system.

The PCI bus 444 may also be coupled to various components including, for example, a network controller 460 that is coupled to a network port (not shown). Additional devices may be coupled to the I/O expansion bus 442 and the PCI bus 444, such as an input/output control circuit coupled to a parallel port, serial port, a non-volatile memory, and the like.

Although the description makes reference to specific components of the system 400, it is contemplated that numerous modifications and variations of the described and illustrated embodiments may be possible. For example, instead of memory and I/O hubs, a host bridge controller and system bridge controller may provide equivalent functions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
organizing a memory buffer to receive profile data corresponding to an instruction of interest within a code segment;
instrumenting the code segment to store the profile data in the memory buffer;
storing the profile data in the memory buffer; and
sampling the profile data in the memory buffer.

2. The method of claim 1, further comprising storing at least a portion of the sampled profile data in a profile database.

3. The method of claim 1, further comprising setting a memory pointer of the memory buffer to a starting address of the memory buffer if the memory pointer has reached a maximum address of the memory buffer.

4. The method of claim 2, further comprising optimizing the code segment based on the sampled profile data.

5. The method of claim 1, wherein organizing the memory buffer comprises setting a count of valid entries in the buffer.

6. The method of claim 1, wherein organizing the memory buffer comprises organizing a circular memory buffer.

7. The method of claim 6, wherein the circular memory buffer is sampled substantially contemporaneously with a hardware monitor memory buffer.

8. The method of claim 7, further comprising sizing the circular memory buffer such that it is full when the hardware monitor memory buffer becomes full.

9. The method of claim 1, wherein sampling the profile data is performed during execution of the code segment.

10. The method of claim 2, further comprising processing the sampled profile data before storing at least the portion of the sampled profile data.

11. A method comprising:
storing information corresponding to an instruction of interest within a code segment in a memory buffer;
sampling the information in the memory buffer; and
storing the sampled information in a profile database.

12. The method of claim 11, further comprising organizing the memory buffer to receive the information.

13. The method of claim 11, further comprising inserting at least one instruction into the code segment to store the information in the memory buffer.

14. The method of claim 11, further comprising sampling at least one hardware monitor memory buffer to obtain hardware information.

15. The method of claim 14, further comprising storing the hardware information in the profile database.

16. The method of claim 11, further comprising storing the information corresponding to the instruction of interest in a circular memory buffer.

17. The method of claim 11, further comprising sampling the information in the memory buffer during execution of the code segment.

18. An article comprising a machine-readable storage medium containing instructions that if executed enable a system to:
store information corresponding to an instruction of interest within a code segment in a memory buffer;
sample the information in the memory buffer; and
store the sampled information in a profile database.

19. The article of claim 18, further comprising instructions that if executed enable the system to organize the memory buffer to receive the information.

20. The article of claim 19, further comprising instructions that if executed enable the system to set a memory pointer of the memory buffer to a starting address of the memory buffer if the memory pointer has reached a maximum address of the memory buffer.

21. A system comprising:
at least one storage device containing instructions that if executed enable the system to store information corresponding to an instruction of interest within a code segment in a memory buffer; sample the information in the memory buffer; and store the sampled information in a profile database; and
a processor coupled to the at least one storage device to execute the instructions.

22. The system of claim 21, further comprising instructions that if executed enable the system to sample at least one hardware monitor memory buffer to obtain hardware information.

23. The system of claim 22, further comprising instructions that if executed enable the system to store the hardware information in the profile database.

24. The system of claim 21, wherein the memory buffer comprises a circular memory buffer.
